(19) United States
(12) Patent Application Publication
(10) Pub. No.: US 2006/0076380 A1
(43) Pub. Date: Apr. 13, 2006

(54) Quick release adapters for bicycle accessory mounting and quick tow mechanism for a bicycle frame

(76) Inventor: Lynn Marie Ockenden, Minneapolis, MN (US)

Correspondence Address: NORTH OAKS PATENT AGENCY, 45 ISLAND ROAD, NORTH OAKS, MN, 55127, US

(21) Appl. No.: 11/241,717

(22) Filed: Sep. 29, 2005

Related U.S. Application Data
(60) Provisional application No. 60/614,282, filed on Sep. 29, 2004.

(51) Int. Cl. B62J 9/00

(52) U.S. Cl. 224/419; 224/447; 224/459

(57) ABSTRACT

Several versions of quick release adapters for bicycle accessory mounting are disclosed. The quick release adapters include either a thumb screw, a cam lever, or a cam ball pivotally attached to a screw that mates with an accessory leg and screws into a hole in a bicycle dropout. An upper mount for racks or other accessories is also disclosed which attaches to existing fender attachment holes. In addition, a quick tow mechanism for a bicycle frame is disclosed with a perpendicular post and C-shaped base part and a rotor that make attachment of a tow bar very simple and easy for a user.

### RELATED APPLICATIONS

This application claims the benefit of U.S. Provisional Application No. 60/614,282, filed Sep. 29, 2004, entitled “Thumb Screw And Cam Lever For Bicycle Accessory Mounting And Perpendicular Post With Quick Tow Mechanism For A Bicycle Frame”.

### FIELD OF THE INVENTION

The present invention relates generally to apparatus for mounting one or more accessories to a bicycle. More particularly, this invention pertains to a system for interchangeably mounting a variety of accessories, either alone or in simultaneous combination, to a bicycle frame.

### BACKGROUND OF THE INVENTION

There are many accessories that are currently useful to bicyclists. These include removable fenders over the front and/or rear wheels, bicycle cargo carrying racks that may be positioned over either wheel, cargo-carrying racks with integral baskets, saddlebags or panniers that are generally mounted on a cargo-carrying rack and even small trailers for carrying children or other cargo. Recently, electric motors and generators have become popular additions to the bicycle.

While all of the above-indicated accessories are known and available on the market, each accessory typically has its own mounting system by which it is attached to the bicycle. At times, the mounting system of one available accessory makes simultaneous mounting of other accessories difficult, inconvenient, or impossible. Generally, the various accessory mounts are incompatible.

Bicycle accessories of the type described above are typically secured to the frame of a bicycle using threaded fasteners driven into a braze-on, metal straps that are passed around the frame, pipe clamps, U-bolts, and the like. While these means for attaching accessories to a bicycle do have utility, they are not “quick-release”. Furthermore, other than the braze-on, these attachment devices are not part of the bicycle frame itself and rely on a clamping-type mechanical grip that may fail, thereby releasing the accessory or damaging the bicycle frame or its finish. Braze-ons are themselves relatively limited in their location and number.

These attachment devices are also not very adaptable. Where a member of a bicycle frame is not in an assumed orientation or where the frame member is of a different size or shape, the aforementioned prior art accessory attachment devices may not easily be modified to accommodate common variations in bicycle frame size and shape.

Many bicycles currently on the market also incorporate front and/or rear suspension systems that can make it difficult to attach accessories to a bicycle. This creates serious problems in the attachment of accessories to a bicycle frame, as the traditional points of attachment may be in different frames of reference vis-a-vis the frame and the suspension.

Finally, typical prior art accessory attachment devices are not generally able to withstand rigorous loading conditions. Heavy loads, such as those seen in long distance touring bicycles and in work bicycles, may easily exceed the holding abilities of most, if not all, of the aforementioned quick-release accessory attachment devices. The points of attachment are only as sturdy as the mechanical fastener used to secure mounting apparatus to the frame of the bicycle.

Accordingly, a need exists for a comprehensive and uniform system for attaching accessories directly to a bicycle frame.

The present invention provides a solution to this and other problems, and offers other advantages over the prior art.

### BRIEF SUMMARY OF THE INVENTION

Several versions of quick release adapters for bicycle accessory mounting are disclosed. The quick release adapters include either a thumb screw, a cam lever, or a cam ball pivotally attached to a screw that mates with an accessory leg and screws into a hole in a bicycle dropout. An upper mount for racks or other accessories is also disclosed which attaches to existing fender attachment holes. In addition, a quick tow mechanism for a bicycle frame is disclosed with a perpendicular post and C-shaped base part and a rotor that make attachment of a tow bar very simple and easy for a user.

Additional advantages and features of the invention will be set forth in part in the description which follows, and in part, will become apparent to those skilled in the art upon examination of the following or may be learned by practice of the invention.

### BRIEF DESCRIPTION OF THE DRAWINGS

FIG. 1 is a left side view of a bicycle shown in phantom and upon which a multipurpose mounting apparatus embodying the invention is shown with multiple accessories that may be attached to the bicycle either one its own or in combination.

FIGS. 2 through 9 are various perspective, enlarged and exploded views of a quick tow mechanism.

FIGS. 10 through 14 are various perspective, enlarged and exploded views of a thumb screw adapter for a mounting leg of a bicycle accessory.

FIGS. 15 through 17 are various perspective, enlarged and exploded views of a cam screw adapter for a mounting leg of a bicycle accessory that operates similar to the thumb screw adapter shown in FIGS. 10 through 14.

FIGS. 18 through 21 are various perspective, enlarged and exploded views of an alternative cam screw adapter for a mounting leg of a bicycle accessory that operates similar to the cam screw adapter shown in FIGS. 15 through 17.

FIGS. 22 through 23 are front and back perspective views of an upper mount used for securing a permanent rack to the upper bicycle.

### DESCRIPTION OF THE PREFERRED EMBODIMENTS

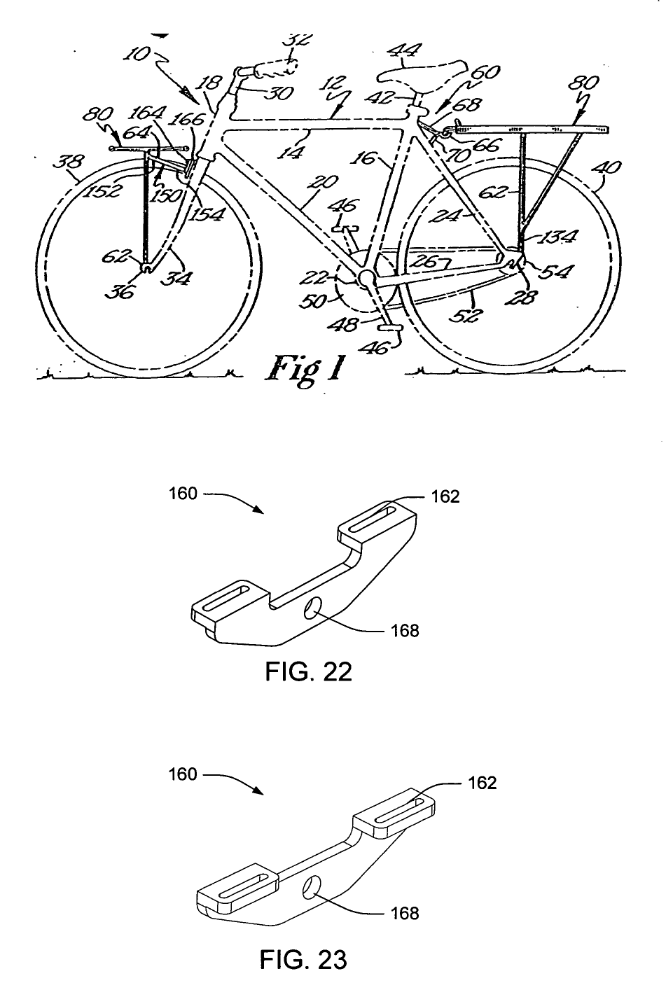

FIG. 1 illustrates a standard bicycle 10 that incorporates the attachment system of the present invention. The bicycle 10 comprises a frame 12 of standard configuration that is made up of a plurality of frame members. While the shape, size, and orientation of the respective frame members may vary with the make of the bicycle, a standard bicycle frame 12 is composed of a top tube 14 that is coupled between a seat tube 16 and a head tube 18. The seat tube 16 receives telescopically therein a seat post 42 that supports the seat 44. A down tube 20 extends between the lower end of the head tube 18 and the bottom bracket 22. The lower end of the seat tube 16 is also connected to the bottom bracket. The rear of the frame 12 comprises a seat stay 24 and a chain stay 26. The seat stay 24 extends from adjacent the intersection of the top tube 14 and the seat tube 16 downwardly into the rear of the frame 12 so as to intersect with a dropout 28. The chain stay 26 is connected between the dropout 28 and the bottom bracket 22. Note that the various frame members 14-28 are typically connected to one another via welding or similar processes where the frame 12 is fashioned of a metallic substance, though they may be connected by the use of an adhesive where the frame members are fashioned from a composite material.

The head tube 18 is received therethrough a headset 30. The handlebars 32 of the bicycle 10 are secured to the upper end of the headset 30. The lower end of the headset has secured thereto the front fork 34. At the lower end of the front forks is a simplified front dropout 36 that supports the front wheel 38. The rear wheel 40 is similarly supported in the rear dropout 28.

Motive power for the bicycle 10 is provided by means of the pedals 46 that are supported on crank arms 48. The crank arms 48 pass through the bottom bracket 22 and are rotatably supported therein. A chain wheel 50 is secured to the crank arms and rotates therewith. A chain 52 shown in FIG. 1 as a dashed line passes around the chain wheel 50 and a smaller chain wheel 54 that is mounted on the rear axle of the rear wheel 40.

The attachment system of the present invention essentially comprises an upper mount 60 that is secured to the frame 12 at or near the junction between the seat stay 24 and the seat tube 16. The attachment system also includes one or more accessory mounting posts 62 that extend generally upward from the dropout 28 or 36. In addition, the attachment system includes a support arm 64 that may be secured between either the front fork 34 and a bicycle accessory 80 as shown in FIG. 1 or between the seat stay 24 and a bicycle accessory 80.

The upper mount essentially comprises a trough or channel 66 that is secured to the bicycle frame 12. Preferably, the channel 66 will be secured to the bicycle frame 12 by means of a cantilever arm 68, though it is to be understood that the channel 66 could be affixed directly to the bicycle frame 12. The channel 66 is secured to the cantilever arm 68 preferably as by welding so as to create a unitary structure. The cantilever arm 68 is in turn secured to the bicycle frame 12 by means of welding, where the upper mount 60 is to be formed integrally with the frame 12, or through the use of various types of clamping mechanisms, such as a U-bolt or the like, where the upper mount 60 is to be retrofit to the bicycle frame 12. Note that the upper mount 60 may be retrofit to a bicycle permanently by welding the cantilever arm 68 or the channel 66 directly to the frame 12. Whether the upper mount 60 is formed integrally with the frame 12 or retrofit thereto, it may be desirable to provide an angled support 70 that extends between the cantilever arm 68 or channel 66 and the seat stay 24. Where desirable, a base end of the cantilever arm 68 may be provided with a bore through which the seat tube 42 may pass. Utilizing this embodiment, the upper mount 60 may be supported by the seat tube 42 rather than by the frame 12.

The channel 66 of the upper mount 60 may have any useful shape. The channel 66 is constructed and arranged to receive therein a member of the bicycle luggage rack 80 so as to secure the rack 80 to the frame 12 of the bicycle 10. Preferably, the channel 66 will be constructed and arranged to receive and retain a portion of the rack 80, in a close fitting engagement therewith.

Accessories which are mounted to the attachment system by bilateral legs are denoted herein as “primary accessories” and include a hitch assembly and a luggage carrier. Accessories that are not directly mounted to attachment system are denoted herein as “secondary accessories”. Such accessories include wheeled trailers such as a golf cart as well as a top basket, side baskets, panniers/saddlebags, wheel fenders, and lights/reflectors.

A hitch assembly is useful for towing various types of trailers such as a golf cart. Other accessories such as a luggage rack or carrier, top basket and pannier which may be attached to the luggage carrier, and a wheel fender may be simultaneously or selectively added in the attachment system. Each of the hitch assembly, carrier, and fender have elongate legs with lower ends which may be mounted bilaterally, i.e. one on each side of the wheel, in a receiving aperture such as apertures of the lower attachment assembly described hereafter.

Referring now to FIGS. 22 and 23 are back and front perspective views, respectively, of an alternative upper mount 160 used for securing a permanent rack to the upper bicycle. The upper mount 160 can be used in the same manner as upper mount 60 described above. The upper mount 160 is a slotted 162 plate secured through a mounting hole 168 to the bicycle 10 through existing holes on the made for permanent fender applications. These existing holes may be located in the head tube 18 or further down near the front fork 34. The upper mount 160 is designed to be used alone or in conjunction with permanent fenders. The upper mount 160 can be mounted on the front or rear of the bicycle 10 in a similar location as upper mount 60. In addition, the racks or other accessories used with the upper mount 160 can be designed to be interchangeable between the front and rear of the bicycle 10.

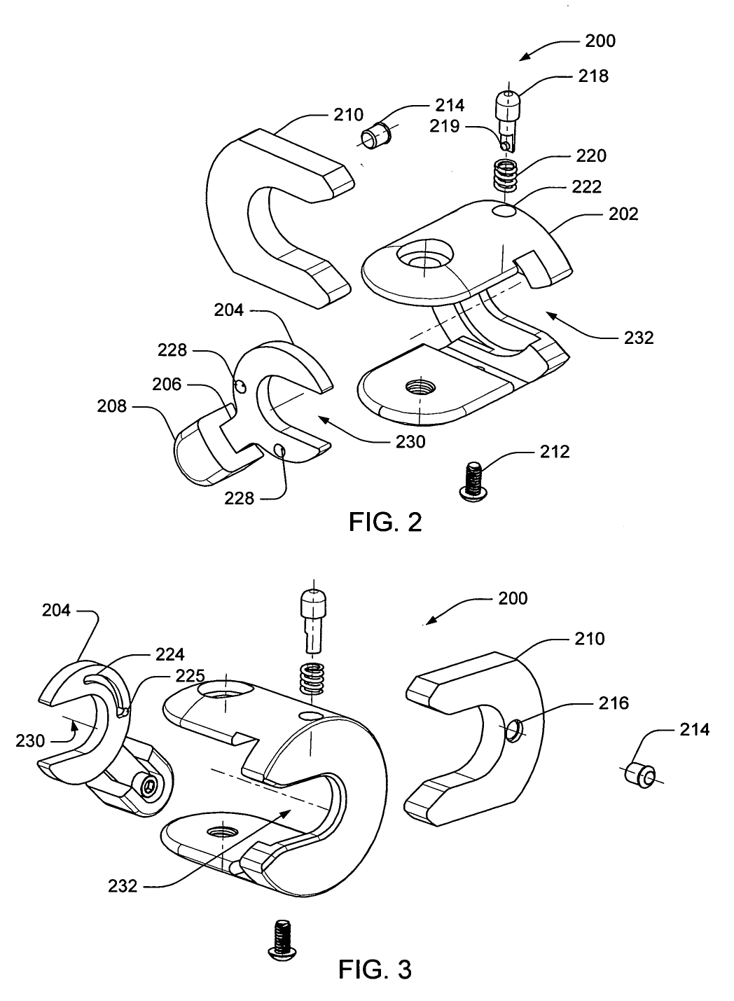

Referring now to FIGS. 2 through 9 where various perspective, enlarged and exploded views of a quick tow mechanism 200 are shown. The quick tow mechanism 200 includes C-shaped base part 202 and a rotor 204 with a lever arm 206 coated with a soft rubber 208. A retainer plate 210 holds the rotor 204 in the C-shaped base part 202 with the assistance of a final screw 212. The retainer plate 210 holds a ball plunger 214 inserted into an aperture 216 of the plate 210. A keyed button head 218 and associated key spring 220 is inserted into an aperture 222 on the C-shaped base part 202. The C-shaped base part 202 is made of machined steel, but could be cast steel or iron, aluminum or plastic material that is sufficiently strong to pull a towing hitch and assembly. The C-shaped base part 202 may be plated with nickel to provide a good fit and finish. In operation, the key 219 slides within a groove 224 in the rotor 210 as shown in FIGS. 8 and 9. The ball plunger 214 engages receiving indents 228 in the rotor 204 when the rotor 204 is located in the open and closed positions to releasably detain the rotor 204 in those positions. The key button head 218 is extended outward from the rotor 204 when the rotor 204 is in the locked or closed position. Similarly, the key button head 218 is down or inset in the base part 202 when the rotor 204 is in the open position that permits the quick tow mechanism 200 to be mounted on the perpendicular post 226.

The quick tow mechanism 200 is mounted on a perpendicular post 226 on a dropout 234 as shown in FIGS. 5 and 7. The post 226 can be integral to the bicycle 10 if the dropout 234 is cast or added later to a custom stamped, cast, cut, or forged metal dropout 234. The dropout 234 may have a luggage rack post hole 240, a mudguard post hole 242, and an eyelet for the perpendicular post 244. By locating the post 226 near the axle of the rear wheel in the crux of the frame's triangle, the post 226 inherently provides optimal strength and a low gravitational center for stable towing. The post 226 also provides a platform for future heavy accessories such as an electric motor. The quick tow mechanism 200 can be retrofit onto most trailers tow bars 238 by removing and replacing a screw 236.

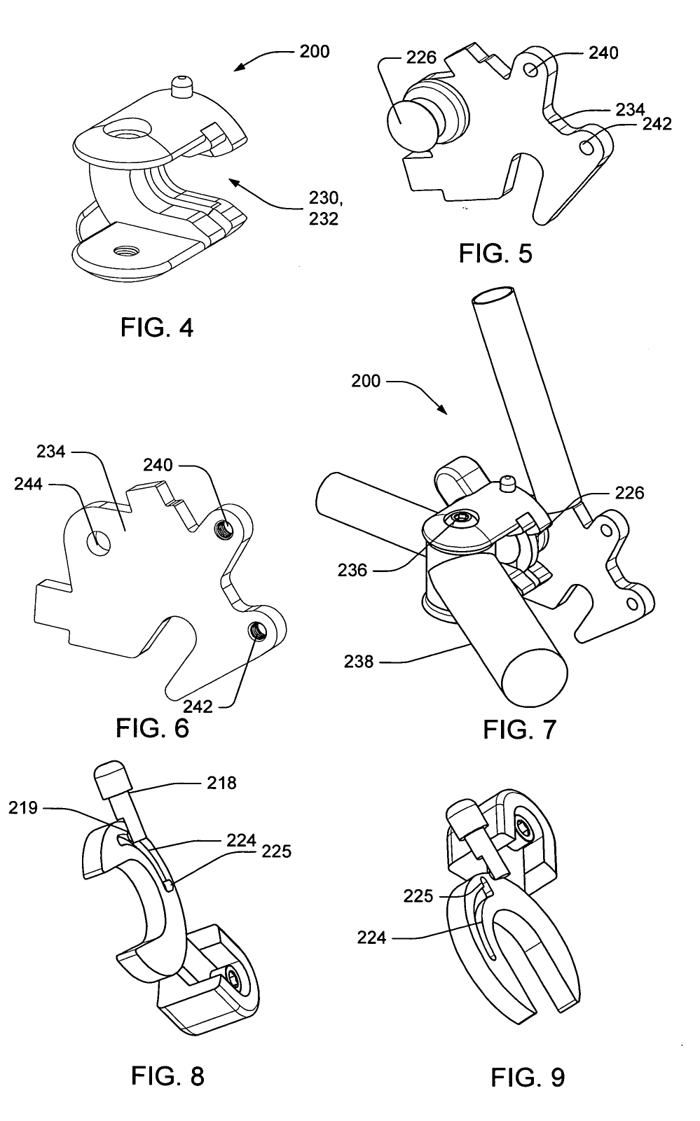

In operation, the quick tow mechanism 200 begins in an open position as shown in FIG. 4. The open position is characterized by the open part 230 of the rotor 204 being aligned with the open part 232 of the C-shaped base part 202 such that the quick tow mechanism 200 is ready to receive a perpendicular post 226. The rotor 204 is stayed by the ball plunger 214 within one of the rotor 204 receiving indents 228. In the open position, the button head 218 is depressed and its key 219 is in the rotor's curved slot or groove 224. When the rotor handle or lever 206 is tugged to release the ball plunger 214 and lifted up to begin closing the quick tow mechanism 200, the key 219 follows the rotor's slot 224 and the button head 218 remains in its inset or depressed position. When the quick tow mechanism 200 reaches its closed position, the button head 218 pops up as the spring 220 brings the key 219 up into the groove or slot's upper end 225 and locks the rotor 204 into its closed position. The ball plunger 214 engages with the rotor's second indent 228 further staying it. To release the rotor lock, a user must depress the button head 218 and tug on the rotor lever or handle 206.

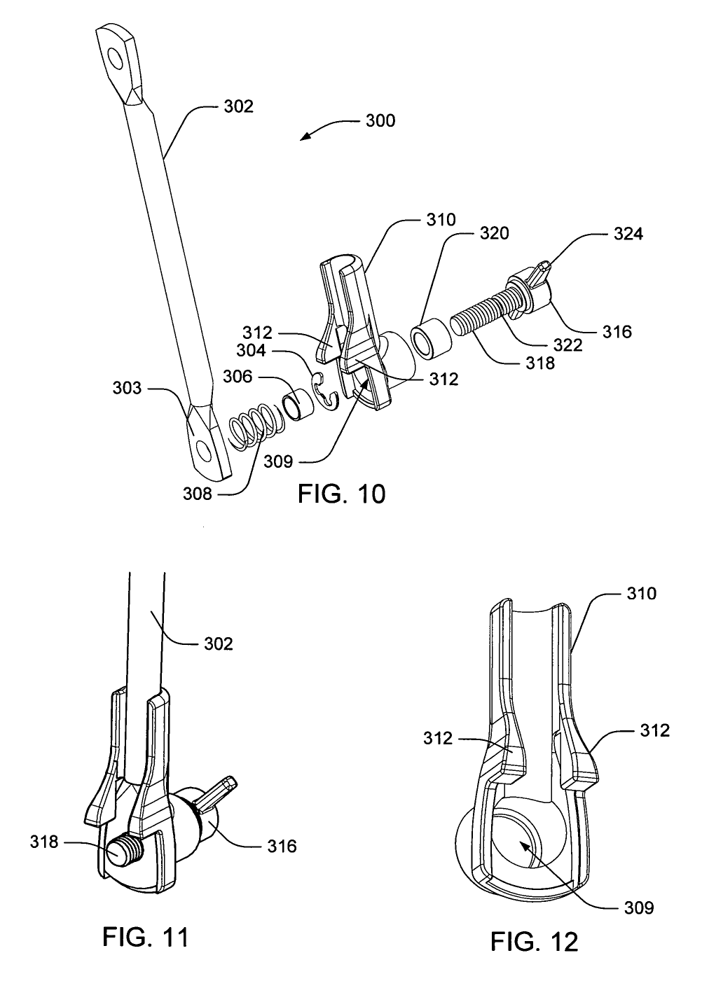

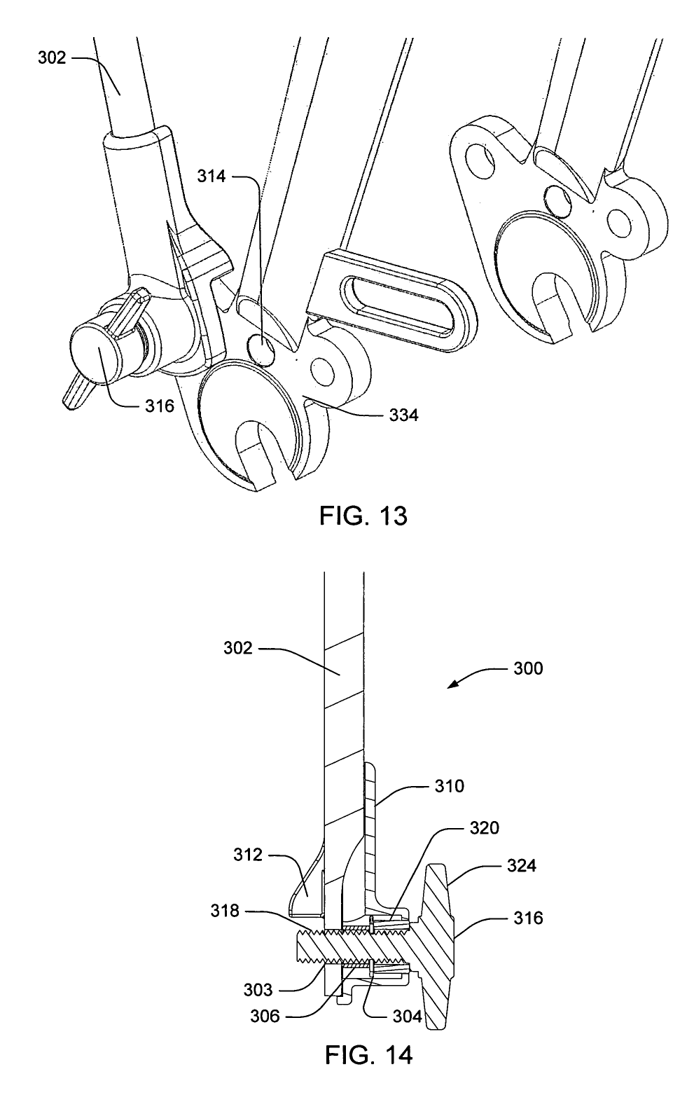

Referring now to FIGS. 10 through 14 where various perspective, enlarged and exploded views of a quick release thumb screw adapter 300 for a mounting leg 302 of a bicycle accessory are shown. The exploded view of FIG. 10 shows how a retaining clip 304, sleeve 306, and spring 308 are positioned to be dropped into the boss or aperture 309 of the plastic body 310. The accessory leg 302 may be snapped into place within the plastic body 310 around the wings 312 to compress the spring 308. FIG. 11 shows a fully assembled thumb screw adapter 300 and accessory leg 302. FIG. 12 shows the plastic body 310 alone and give a detailed view of the boss or aperture 309. FIG. 13 shows the assembled thumb screw adapter 300 and accessory leg 302 mounted in a mounting hold 314 near a dropout 334. The spring 308 biases the thumb screw 316 to help align the screw portion 318 with a mounting hole 314 located on the bicycle frame such as that near a front or rear dropout 334. When the thumb screw 316 is opened using the thumb screw handle 324, the red sleeve 320 is visible to a user. When fully tightened, the red sleeve 320 is concealed from the user by the molded plastic body 310. This use of a colored sleeve 320 is a safety feature to show loosening of the thumb screw 316. It will be appreciated by those skilled in the art that other colored sleeves can be utilized or even a sleeve with no different coloring from the other components can be utilized.

Assembly of the quick release thumb screw adapter 300 begins with the plastic body 310 and integral boss aperture 309. The retainer clip 304, sleeve 306, and spring 308 are dropped into the boss 309. The upper leg 302 of an accessory is snapped into its seat such that the spring 308 is compressed into the boss aperture 309. The plastic body 310 is slid into position up the accessory leg 302 until the motion is blocked and the rack's flat end 303 snaps into its seat. The thumb screw 316 plus red sleeve 320 are inserted into the other side of the boss 309 and tightened until the inside retainer clip 304 locks on the groove 322 of the screw 316.

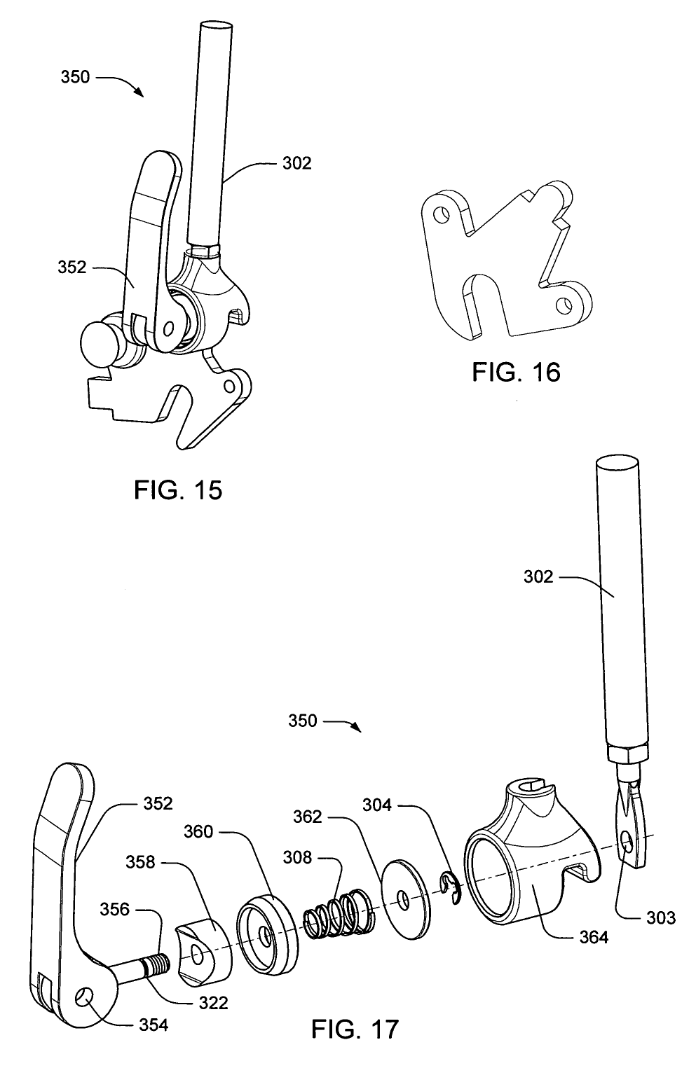

Referring now to FIGS. 15 through 17 where various perspective, shown are enlarged and exploded views of a cam screw adapter 350 for a mounting leg 302 of a bicycle accessory that operates similar to the thumb screw adapter 300 shown in FIGS. 10 through 14. The cam latch 352 is pivotally mounted 354 on an end of a screw 356. When in a locked position, the cam latch 352 is parallel to the accessory leg 302 as shown in FIG. 15. The cam latch 352 works cooperatively with the cam seat 358 to provide a locked position and unlock position of the cam latch 352 with screw assembly 356. The metal housing 360 performs a similar function as sleeve 320 that was described previously. Metal housing 360 also provides a pivot point surface for cam seat 358 to rotate within when assembled. The metal housing 360 works in cooperation with washer 362 to hold the spring 308 in position. Spring 308 may optionally be omitted when plastic body 364 is made of sufficiently durable material to hold the spring 308 and cam latch 352 through multiple opening and closing operations. Plastic body 352 is formed in a similar manner as plastic body 310 and performs the same function of holding the cam screw adapter 350 to the accessory leg 302. Also, in a similar way retainer clip 304 snaps into groove 322 when assembled.

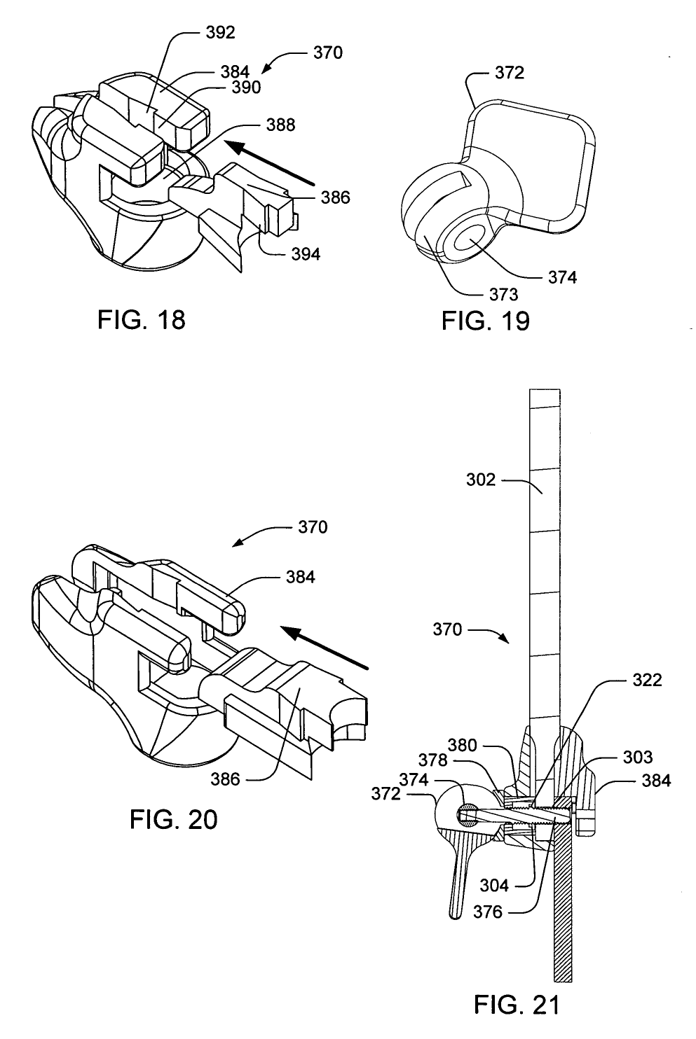

Referring now to FIGS. 18 through 21 where various perspective, enlarged and exploded views of a cam ball adapter 370 for a mounting leg 302 of a bicycle accessory is shown that operates similar to the cam latch adapter 350 which was shown in FIGS. 15 through 17. The cam ball adapter 370 has fewer parts (e.g., no spring 308) than cam latch adapter 350 and is pivotally mounted 374 on an end of a screw 357. When in a locked position, the cam ball 372 is parallel to the accessory leg 302 as shown in FIG. 21. The cam ball 372 works cooperatively with the cam seat 378 to provide a locked position and unlock position of the cam ball 372 with screw assembly 376. FIG. 18 and FIG. 20 show alternative embodiments of the cam ball adapter 370 for different sizes of accessory arms 302. In the locked position the cam ball 372 may be adjacent to the accessory leg 302 or down and away 388 from the accessory leg 302. This bidirectional movement of the cam ball 372 is enabled by wide sides and a pin/screw that is centered and a rounded cam end 373 fits into the metal housing 380 such that the two parts are self aligned with one another. Metal housing 380 performs a similar function as housing 360 as a spacer in the bore or aperture 388. Plastic body 384 is formed in a similar manner as plastic body 352 and performs the same function of holding the cam screw adapter 370 to the accessory leg 302. A plastic body lock insert 386 with lock part 394 is slide into slot 390 and engage lock receiver 392. Also, in a similar way retainer clip 304 snaps into groove 322 when assembled.

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed.

1. A quick tow mechanism for use with a bicycle frame that has a perpendicular post located near a rear dropout, the quick tow mechanism comprising:
a C-shaped base part with an opening configured to accept the perpendicular post, the base part including two ears configured to attach to an accessory leg; and
a rotor formed to fit within the C-shaped base part, the rotor having an opening and a lever arm which when manipulated moves the rotor between an open and closed position, the open position being characterized by the rotor opening being aligned with the C-shaped base part opening such that the quick tow mechanism is read to receive the perpendicular post.

2. The quick tow mechanism of claim 1 further comprising a retaining plate configured to secure the rotor within the base, the retaining plate including an aperture for a ball plunger.

3. The quick tow mechanism of claim 2 wherein the base part comprises a seat configured to receive the rotor, an aperture for a key, and an aperture for a final screw to hold the base part, plate and rotor together.

4. The quick tow mechanism of claim 2 further comprising the ball plunger.

5. The quick tow mechanism of claim 2 wherein the rotor comprises a groove configured to engage a button head of key, the groove having stops for positioning the rotor in the open and the closed position.

6. A quick tow mechanism for use with a bicycle frame having a perpendicular post, located near a rear dropout and of a strength and configuration to provide a towing platform.

7. The quick tow mechanism of claim 6 wherein the perpendicular post preferably placed forward from the chain stay and seat stay and near the rear dropout.

8. The quick tow mechanism of claim 6 further comprising a C-shaped base part with an opening configured to accept the perpendicular post, the base part including two ears configured to attach to an accessory leg.

9. The quick tow mechanism of claim 8 further comprising a rotor formed to fit within the C-shaped base part, the rotor having an opening and a lever arm which when manipulated moves the rotor between an open and closed position, the open position being characterized by the rotor opening being aligned with the C-shaped base part opening such that the quick tow mechanism is read to receive the perpendicular post.

10. The quick tow mechanism of claim 8 wherein the perpendicular post has a shoulder to protect the dropout from the C-shaped base part and to provide an extended base for better mounting on the dropout so that stress forces are distributed over a larger bearing surface against the dropout.

11. The quick tow mechanism of claim 8 wherein the perpendicular post has a cap at a distal end of post away from a proximal end near the dropout, the cap being configured to retain the C-shaped body part on the post.

12. The quick tow mechanism of claim 6 wherein the perpendicular post is integrally formed in the rear dropout.

13. The quick tow mechanism of claim 6 wherein the rear dropout comprises an eyelet configured for mounting the perpendicular post.

14. A quick release adapter for enabling mounting of a bicycle accessory to a bicycle frame, the adapter comprising:
a housing operatively configured to attach to an accessory leg and having an aperture aligned with an aperture in the accessory leg; and
a screw configured to pass through the housing and accessory leg apertures when one end of the screw engages the bicycle frame, another end of the screw having a lever that allows tool-less application of the screw to the bicycle frame

15. The quick release adapter of claim 14 wherein the lever is a thumb screw.

16. The quick release adapter of claim 14 wherein the lever is a earn lever pivotally attached to the screw.

17. The quick release adapter of claim 14 wherein the lever is a cam ball pivotally attached to the screw.

18. The quick release adapter of claim 14 wherein the screw is configured to thread into a hole in a bicycle dropout.

19. An upper mount for enabling mounting of a bicycle accessory to a bicycle frame through an existing fender attachment hole.

20. The upper mount of claim 19 comprising a slotted plate with a mounting hole, the slotted plate being operatively configured to accept a quick release bicycle accessory, and the mounting hole being operatively configured to align with the existing fender attachment hole when attached to the bicycle frame.

21. The upper mount of claim 20 wherein the slotted plate comprises at least one slot configured to accept the quick release bicycle accessory.

22. The upper mount of claim 20 wherein the bicycle accessory comprises a rack.
